(19) United States
(12) Patent Application Publication
(10) Pub. No.: US 2006/0143155 A1
(43) Pub. Date: Jun. 29, 2006

(54) Method and apparatus for classifying document information

(75) Inventors: Hideko Kagimasa, Tokyo (JP); Toru Takahashi, Tokyo (JP); Yoshifumi Yamashita, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/360,098

(22) Filed: Feb. 22, 2006

Related U.S. Application Data
(63) Continuation of application No. 10/081,488, filed on Feb. 20, 2002.

(30) Foreign Application Priority Data
Jun. 29, 2001 (JP) JP 2001-197686

(51) Int. Cl. G06F 17/30

(52) U.S. Cl. 707/1

(57) ABSTRACT

When registering a document, notify a document registrant of related information of one or more documents similar in content thereto. In addition, upon registration of the document, if a folder is designated as a registration destination thereof then notify the document registrant of relevant information of any available similar documents which reside within the registration destination folder. This permits users to effortlessly recognize and grasp useful relevant information through information publication. This in turn makes it possible to provide users with motivation for progressive or “positive” participation in common sharing of information and knowledge.

### BACKGROUND OF THE INVENTION

The present invention relates generally to electronic document information management architectures and, more particularly, to a method and apparatus for management and classification of document information thereby enabling authorized users to share document information via computer communication networks.

In recent years, wide spread and popularization of computer networks result in any individuals being enabled to directly open or “publish” information to anybody. One example is that a person such as a computer operator or user is enabled to issue information to people anywhere over the world via online computer network services such as electronic news, electronic mails (e-mails) and/or advanced computer system called the World-Wide Web (WWW), which links documents and pictures into a database that is stored in computers in many different parts of the world. Through the individual's information publication attempts based on his or her own free will, s/he has no specific difficulties in appealing self-characteristics and results of labor efforts. In addition, sharing such published individual's effort results and information as well as know-how and knowledge must lead to improvements in intellectual productivity in an organization as a whole.

Such computer networks function as the infrastructure for information sharing. Recent rapid growth in computer network technologies pushes the information-sharing infrastructure to grow to offer enhanced performance and serviceabilies. Unfortunately, such infrastructure growth per se is merely to provide the necessary condition for common sharing or “commonization” of information. Completion of the infrastructure does not automatically guarantee any intended facilitation of the information sharing with increased accessibility and usability.

An advantage as to improvements in intellectual productivity of the entirety of a group is expectable by mutual publication and common sharing, among individual associates or members who belong to the group, of information and knowledge plus know-hows or else which are stored and handled in a way independently of the group members for purposes of improvement in person-based intellectual productivity. Such information sharing over computer networks is typically achievable by use of online electronic bulletin boards and/or web pages on the Internet. Additionally, based on records of access results to presently published information, it is possible for an information publisher to roughly be aware of web-site visitors' reactions to the published information being accessed for referencing purposes.

Conventional known information sharing systems are faced with a problem that any contents are not registered positively. One major reason of this is that troublesome and time-consuming operations are required in document registration events. Another reason lies in the presence of complexities in procedure for selection of an appropriate destination of document file registration. A presently available approach to solving this problem is to employ a technique for enabling establishment of a multi-level hierarchical configuration of folders making up a folder hierarchy to thereby provide computer users with adequate services in a way pursuant to the users' automatic folder classification processing requests, which technique is disclosed in JP-A-2000-89991. A file/folder selection facilitation technique is disclosed in JP-A-9-311805. This technique is for facilitating computer users to select an appropriate file suitable for storage of a new document and also a folder suitable for searching of certain documents that satisfy any desired search conditions.

### SUMMARY OF THE INVENTION

The conventional information sharing systems offer a capability to provide information registration environments with reduced complexities and increased usabilities. Unfortunately these traditional systems fail to provide any successful approach to giving any positive incentive to information providers in accordance with information being provided. Due to this, the systems suffer from a problem as to the incapability to establish positive motivation toward information sharing.

It is therefore an object of the present invention to provide a new and improved electronic document information management technique capable of avoiding the problems in the prior art.

It is another object of this invention to provide a document information management method and apparatus for permitting users to obtain and grasp know-hows of beneficial related information through publication and registration of electronic documents to thereby activate information sharing and/or knowledge sharing more effectively.

To attain the foregoing objects the invention provides a document information management method and apparatus as designed to notify a document registrant of related or relevant information of presently available content-similar documents in a document registration event. Use of the document information management scheme unique to the invention enables users to effortlessly grasp relevant information useful to themselves through publication of information. This makes it possible to establish motivation of positive participation in information-sharing/knowledge-sharing. In this way, it is possible to achieve an advanced scheme, beyond realization of mere information sharing, for giving an information provider positive incentive in accordance with information being provided, which in turn makes it possible to facilitate and activate information sharing.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a block diagram showing an overall configuration of an electronic document management system in accordance with a first embodiment of the present invention.

FIG. 2 is a diagram showing a pictorial representation of the processing in the document management system in accordance with the first embodiment of this invention.

FIG. 3 is a diagram showing one typical example of a display view for new document registration in the document management system of the first embodiment of the invention.

FIG. 4 is a diagram showing an example of users' organization information in the document management system of the first embodiment of the invention.

FIG. 5 is a diagram showing one exemplary organization configuration in the document management system of the first embodiment of the invention.

FIG. 6 is a diagram showing an example of a document registration result view in the document management system of the first embodiment of the invention.

FIG. 7 is a flowchart showing a procedure of document registration processing in the document management system of the first embodiment of the invention.

FIG. 8 is a diagram showing an example of a folder structure in a document management system in accordance with a second embodiment of the instant invention.

FIG. 9 is a diagram showing an example of a document registration result view in the document management system of the second embodiment of the invention.

FIG. 10 is a flowchart showing a procedure of document registration processing in the document management system of the second embodiment of the invention.

FIG. 11 is a diagram showing an example of a document list-up display within a registration destination folder in the document management system of the second embodiment of the invention.

FIG. 12 is a diagram showing an example of a document list display within another folder in the document management system of the second embodiment of the invention.

FIG. 13 is a diagram showing an example of a folder structure in a case a document is registered while being associated with a plurality of folders in a document management system in accordance with a third embodiment of the invention.

FIG. 14 is a diagram showing an example of a folder structure in a case a document is registered with associativity to a plurality of folders in the document management system of the third embodiment of the invention.

### DETAILED DESCRIPTION OF THE EMBODIMENTS

### First Embodiment

A first embodiment of the present invention will now be set forth with reference to some of the accompanying drawings below.

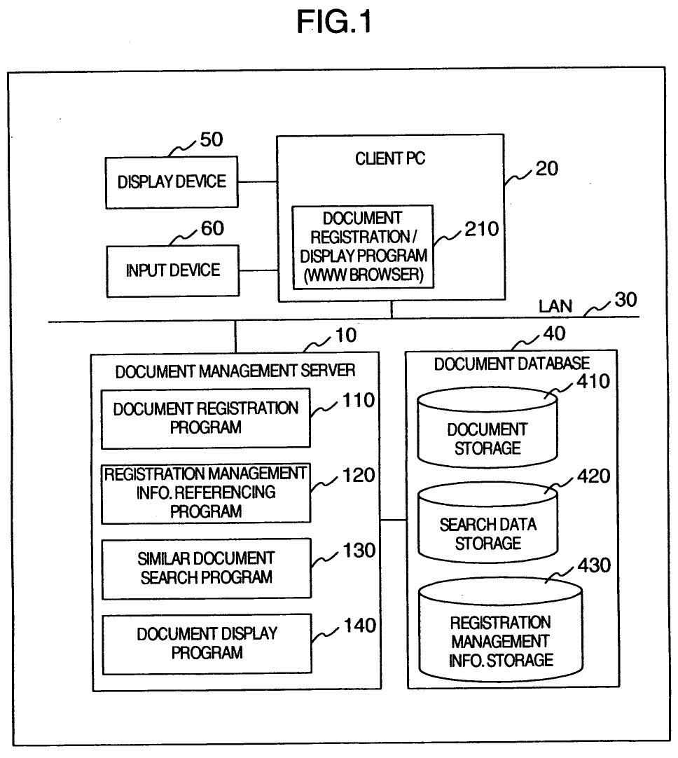

FIG. 1 is a block diagram showing a configuration of an electronic document management system in accordance with an embodiment of the present invention. The document management system shown herein is such that a document management server 10 and a “client” personal computer (PC) 20 are operatively connected together via a network 30 such as a local area network (LAN), Internet, public online communication links or the like. The document management server 10 is generally constituted from a document database 40 and a collection of software programs for control of this database, including a document registration program 110, a registration management information referencing program 120, a similar document search program 130, and a document displaying program 140.

In the illustrative embodiment, the client PC 20 is arranged to include a document registration/display program 210, a display device 50 and an input device 60. The document registration/display program 210 is utilizable by Web browsers and is for operative association with respective programs within the document management server.

The document database 40 is configured from a document storage unit 410 and a search-use data storage unit 420 plus a registration management information storage unit 430. The document storage unit 410 is operable to store therein document data; the search data storage unit 420 stores therein search indexes and search structure indexes; and, the registration management information storage unit 430 stores definition information of properties of an object to be searched.

The above is the configuration of the document management system embodying the invention.

The document management system of this embodiment is arranged to search for more than one similar document while adding designation of a search object structure to search conditions, thereby acquiring related or relevant information of a document being registered. This is realizable by use of a similar document search technique for searching structured documents with increased similarity to a species or “seed” document, as has been disclosed in JP-A-2001-14326.

With the document management system of this embodiment, there is realized a method for permitting computer users to register documents to the document database 40 through the document registration/display program 210. More specifically a user is expected to get the document registration/display program 210 started at the client PC 20 and then designate a file of a document to be registered by use of the input device 60 and also input property values.

The document registration program 110 registers to the document storage unit 410 of the document database 40 more than one registration document file as has been input from the client PC 20 through the document registration/display program 210 along with the properties thereof.

In addition, the document registration program 110 creates search-use data based on the registration document file and its properties and then stores them in the search data storage unit 420 of the document database 40.

Further, the document registration program 110 sets up a species or “seed” document for a similar document search based on the registration document file and its properties.

The registration management information referencing program 120 reads definition information of the properties of a to-be-searched object out of the registration management information storage unit 430 of the document database 40 and then passes it to the document registration program 110.

The similar document search program 130 uses the seed document that was set by the document registration program 110 as a search condition and then conducts a search with respect to the data accumulated in the document database 40. The document display program 140 prepares related information of the registered document on the basis of a search result(s) of the similar document search program 130 and then passes it to the document registration/display program 210. The document registration/display program 210 visually displays the relevant information of such registered document on the display 50.

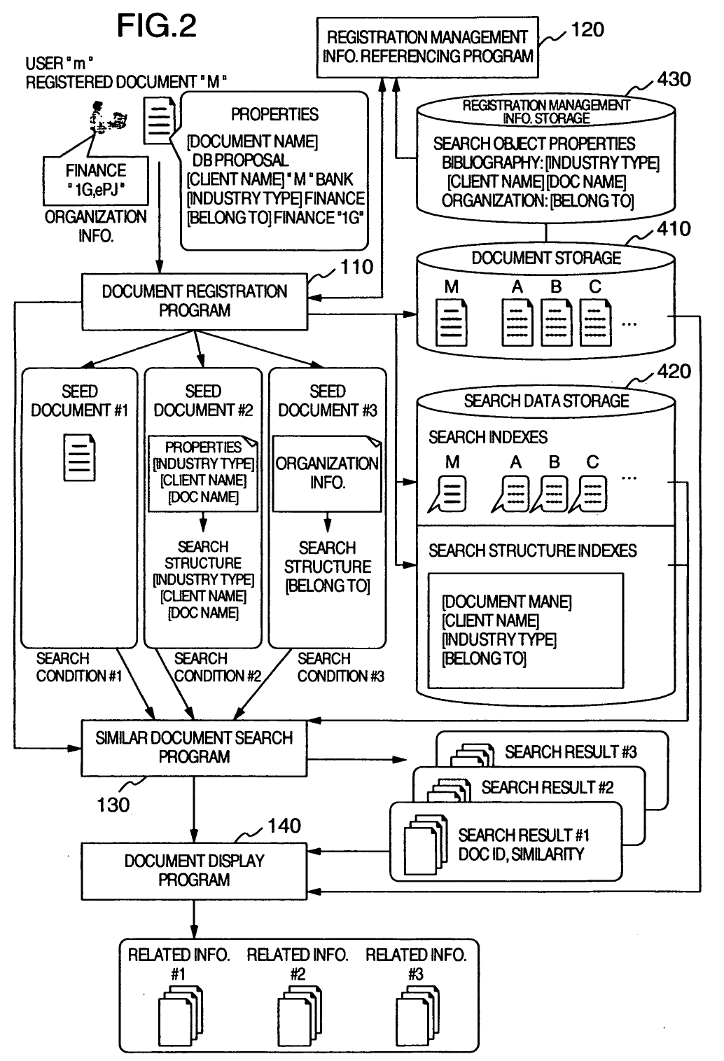

A detailed explanation will next be given of an overview of the processing to be executed by the document management system in the illustrative embodiment. See FIG. 2, which is a diagram showing an outline of the processing of the document management system in accordance with the first embodiment.

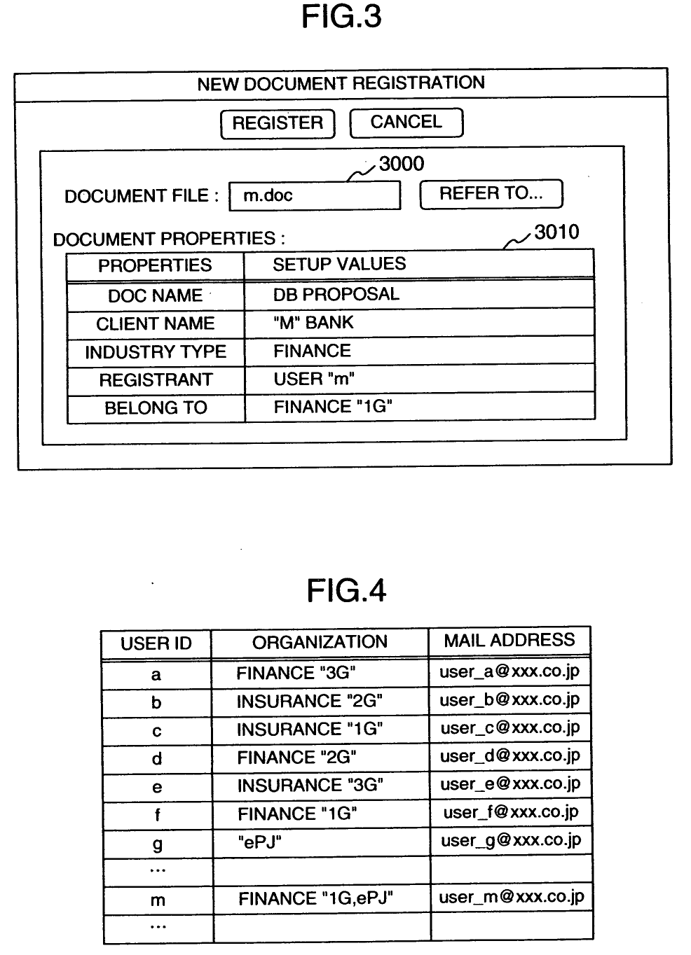

As shown in FIG. 2, when a user “m” first designates a file of a to-be-registered document “M” from the document registration/display program 210 and then inputs one or more property values, the document registration program 110 is called for execution of registration processing required. Here, one example of a new document registration view as displayed under control of the document registration/display program 210 is shown in FIG. 3. This new document registration view comes with several items, including a document file 3000 and document properties 3010. Designation of the document file 3000 may be done by either direct input of a file name such as “m.doc” or alternatively by selection of an appropriate one from among a list of “candidates” of document names being displayed after clicking on a reference button icon. The document properties 3010 are to be input in such a way that a document name is “DB Proposal” with a client name specified as “M bank”. Lastly, upon clicking a registration button, the registration processing is executed.

The document registration program 110 in FIG. 2 forms a search index M on the basis of the content of a file of a document M to be registered and then stores it in the search data storage unit 420. Next, the document registration program 110 calls the registration management information referencing program 120 and then reads from the registration management information storage unit 430 definition information of the properties of an object to be searched. The search object property definition information defines more than one property for use as an object upon searching for related information of bibliography and relevant information of an organization. In the example of FIG. 2, definition is made in such a way which follows: in the case of bibliography, property values of “Industry Type” and “Client Name” plus “Document Name” are regarded as the objects of interest; in the case of organization the property value of “Belong To” is regarded as the object. The document registration program 110 is operatively responsive to receipt of the definition information of the above-noted search object(s) for producing more than one search structure index on the basis of the values of the registration document M's properties “Industry Type”, “Client Name”, “Document Name” and “Belong To”, which will then be stored in the search data storage unit 420.

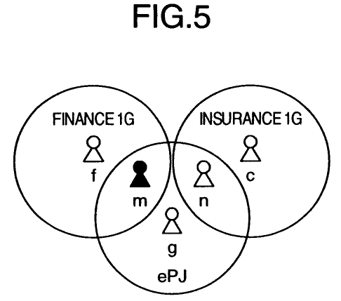

Next, the document registration program 110 sets up a species or “seed” document for a similar document search based on the registration document M's file and properties. Firstly, set in the seed document a content of the file of registration document M; then, let it be a search condition 1. Next, set in the seed document a value “Finance” of the property “Industry Type” of the registration document M, a value “M Bank” of the property “Client Name” and a value “DB Proposal” of the property “Document Name”; then, let them be a search condition 2. Next, refer to organization information to which the registered user m belongs to thereby set “Finance 1G, ePJ” in the seed document; then, let it be a search condition 3. Here, an example of the user's organization information is shown in FIG. 4. The organization information consists essentially of a user ID, organization and mail address. For instance, in case the user ID is “a”, it indicates that the user belongs to the organization “Finance 3G” and that his or her mail address is “user_a.xxx.co.jp”. Alternatively in the case of a user ID “m” as exemplarily shown in FIG. 2, the organization becomes “Finance 1G, ePJ”. This indicates that the user m belongs to two organizations of a group “Finance 1G” and a project “ePJ” as better shown in an organization constitution diagram of FIG. 5.

Next the document registration program 110 calls the similar document search program 130 for execution of similar document search processing. As a result of such similar document searching, a document ID and similarity of more than one similar document are obtained.

The similar document search program 130 first conducts a search for any available similar document(s) with respect to the search condition 1 to thereby obtain a result, which is regarded as a search result 1. Next, with regard to the search condition 2, designate “Industry Type”, “Client Name” and “Document Name” as search object structures and then searches similar documents. Let this result be a search result 2. Further, regarding the search condition 3, designate “Belong To” as a search object structure; then, search similar documents. Let this result be a search result 3.

The document display program 140 performs sorting in the order of higher similarities on the basis of the search results of the similar document search program 130 and then prepares a list of related information items with the similarity and document ID plus document name and the like being as items to be visually displayed.

What has been discussed above is an explanation of the processing summary of the document management system in accordance with the first embodiment.

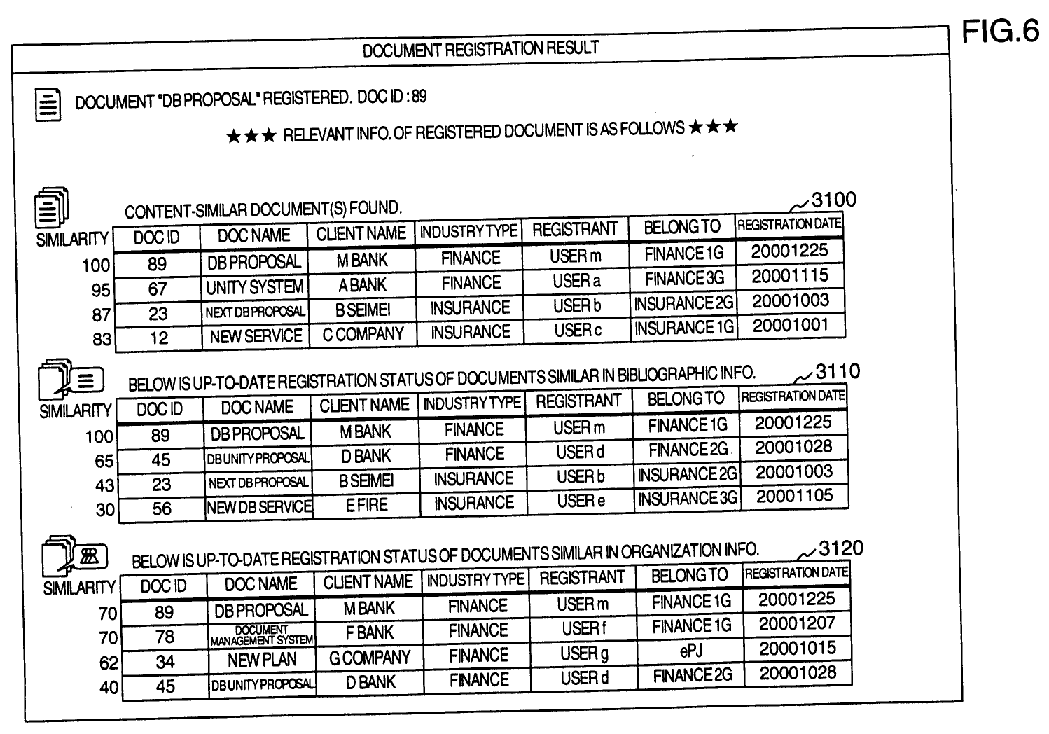

An explanation will next be given of a summary of a display method of the document registration/display program 210 in this embodiment. There is shown in FIG. 6 an example of a document registration result display view that the document registration/display program 210 visually displays a result of document registration. FIG. 6 is a view to be displayed as a result of new document registration as exemplarily shown in FIG. 3. The document registration result view displays a document ID as newly assigned to the presently registered documents along with related information thereof. One example is that in the case of a document “DB Proposal”, it is registered with a document ID 89. On the document registration result view of FIG. 6, a list of documents which are similar to the registration document in content and bibliographic information plus organization information is displayed as the related information of the registration document. The related information is constituted from related information 3100 concerning the content, related information 3110 as to the bibliographic information, and related information 3120 about the organization information.

In the document registration result view each related information consists essentially of prespecified display items including the similarity, document ID, document name, client name, industry type, belong-to, and registration date, wherein the documents are displayed in such a manner that these are listed in the order that a document of higher similarity precedes the others. When a computer user clicks the document name of any given document within the related information, a corresponding application gets started enabling the user to refer to a document content. Alternatively when the user clicks the registrant of any given document within the related information, s/he can refer to an electronic mail (e-mail) address of the registrant.

The related information 3100 is a list of certain documents that are similar in content to the registration document. In this example, first, the registration document per se is displayed as a similarity 100 at the top of the list; next, a list of documents is being displayed in such a manner that their similarities are sorted in the order of 95, 87, and 83. In this case, the user “m” who is a document registrant can recognize that a user “a” who is in charge of clients of the same industry type and another user “b” who is expected to handle clients of a different industry type have already registered proposal documents which are much similar in content while also being permitted to perform communications with them whenever the need arises. Whereby, they are enabled to share know-hows such as common technical information, problems to be solved, client needs and others, without regard to differences in industry type.

The related information 3110 is for indication of an up-to-date registration situation of some documents similar in bibliographic information. Displayed as the bibliographic information is the similarity with document name and client name plus industry type being as the objects of interest. In this example, first, the registration document per se is displayed with a similarity 100 at the top of the list; next, a document list is being displayed in such a manner that similarities are in the order of 65, 43 and 30. In this case it is possible for the user m who is the document registrant to recognize that a user “d” who is in charge of clients of the same industry type and the user “b” who is expected to handle clients of a different industry type have already registered their proposal documents much similar in content while also being permitted to perform communications with them when the need arises. Whereby, they are enabled to share know-hows such as a wide variety of client needs and case-study information or else.

The related information 3120 is the one that indicates the last updated registration situation of documents similar in organization information. Displayed as the organization information is a list of documents of “Belong To” having similar values to the organization “Finance 1G, ePJ” to which the user m belongs. In this example the registration document per se is first displayed with a similarity 70 at the top of the list; next, a document list is displayed in such a manner that similarities are in the order of 70, 62 and 40. This makes it possible for the user m who is the document registrant to grasp the up-to-date registration situation of a user “f” in the same group and also that of a user “g” in the same project, which in turn enables them to share business in-progress information and know-hows.

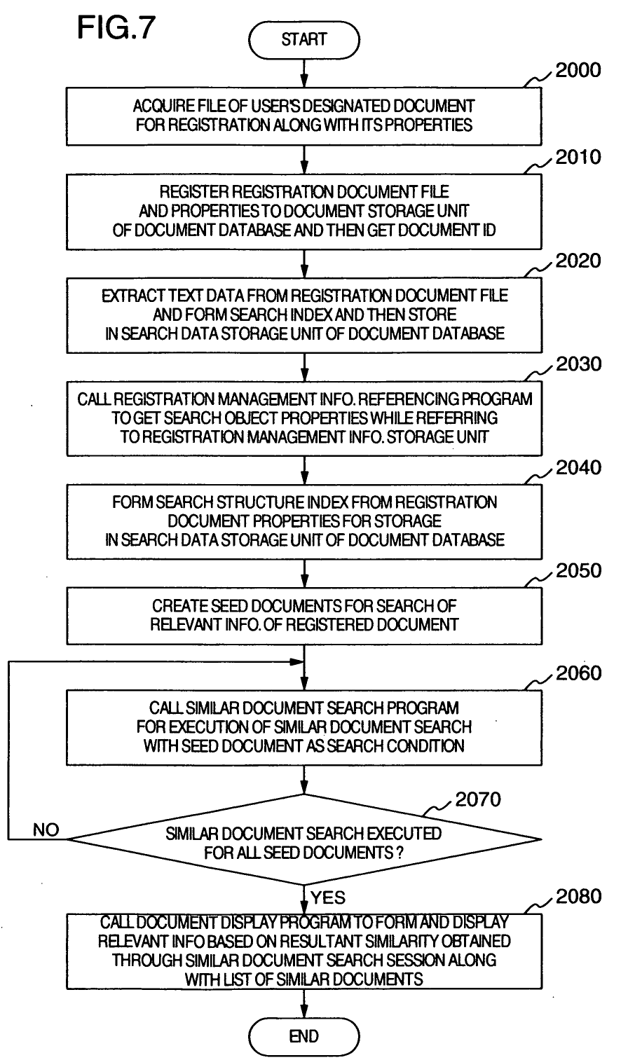

An explanation will next be given of a detailed procedure of document registration processing of the document registration program 110 of the illustrative embodiment, with reference to a flowchart of FIG. 7.

At step 2000 of FIG. 7, acquire a file of the user's designated document for registration along with its properties.

At step 2010, register the registration document file and its properties to the document storage unit 410 of the document database 40; then, obtain a document ID.

At step 2020, extract text data from a content of the registration document file; then, create more than one search index; next, store it in the search data storage unit 420 of document database 40.

At step 2030, call the registration management information referencing program 120 to obtain definition information of the to-be-searched object's properties while referring to the registration management information storage unit 430.

At step 2040 prepare a search structure index from the property value(s) of the registration document and then store it in the search data storage unit 420 of the document database 40.

At step 2050 create one or more species or “seed” documents for use during search for any available related information of the document being registered.

At step 2060 call the similar document search program 130 for execution of a similar document search with the seed documents as search conditions.

At step 2070 determine whether the similar document search has been executed relative to all the seed documents involved. If YES at step 2070 then the system procedure goes to step 2080. If NO at step 2070 then return to step 2060.

At step 2080, call the document display program 140 which makes use of both the similarity obtained as a result of the similar document search session and the resultant list of similar documents to prepare related information for visual on-screen display purposes.

Upon completion of the user's document registration in the way stated above, a list of specific documents is visually displayed as the related information required, which documents are similar to the registration document in content and in bibliographic information and also in organization information. Whereby it becomes possible for the user to grasp related information beneficial to himself or herself through publication of information without suffering from any troublesome and time-consuming works, which in turn provides motivation of positive and “aggressive” participation in information-sharing/knowledge-sharing.

In addition, when the user performs document registration in the way discussed above, related information as to the content of such document is visually displayed. Thus it is possible for the user to become aware of the presence of business, personnel or organization having similar purposes and a tackle situation in a view point of the similarity of document content through the user's document publication, which in turn makes it possible for the user to grasp any available related or relevant information that is useful to himself or herself.

In addition, when the user performs document registration in the way stated above, related information as to the bibliographic information of such document is visually displayed. Thus it is possible for the user to become aware of the presence of a business or personnel in similar fields or categories and a tackle situation in a view point of the similarity of document bibliographic information through the user's document publication, which in turn makes it possible for the user to grasp any available related or relevant information useful to himself or herself.

Additionally, when the user performs document registration in the way noted above, related information as to the organization information is visually displayed. Thus it is possible for the user to become aware of the document registration situation and/or in-progress status or else of the people who takes part of the same business in a viewpoint of the similarity of the registrant's organization information through the user's document publication, which in turn makes it possible for the user to grasp any available relevant information useful to himself or herself.

Optionally it may also be possible to select for display certain documents high in similarity from among the related information items of the registration document. This makes it possible for the user to efficiently grasp his or her useful relevant information.

With the procedure discussed above, it is possible to accelerate plus (facilitation) factors on the document provider side, thereby enabling establishment of motivation of positive participation in information-sharing/knowledge-sharing. In other words, it is possible to give positive incentive to information providers in accordance with provision information rather than realization of mere information sharing, thus enabling facilitation and activation of information sharing. The above is the explanation of the first embodiment of the present invention.

### Second Embodiment

An explanation will be given of an event for document registration with a folder designated, as a second embodiment of the present invention, with reference to some of the attached drawings.

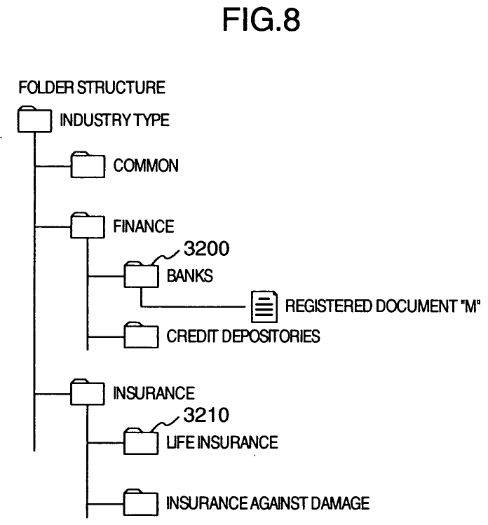

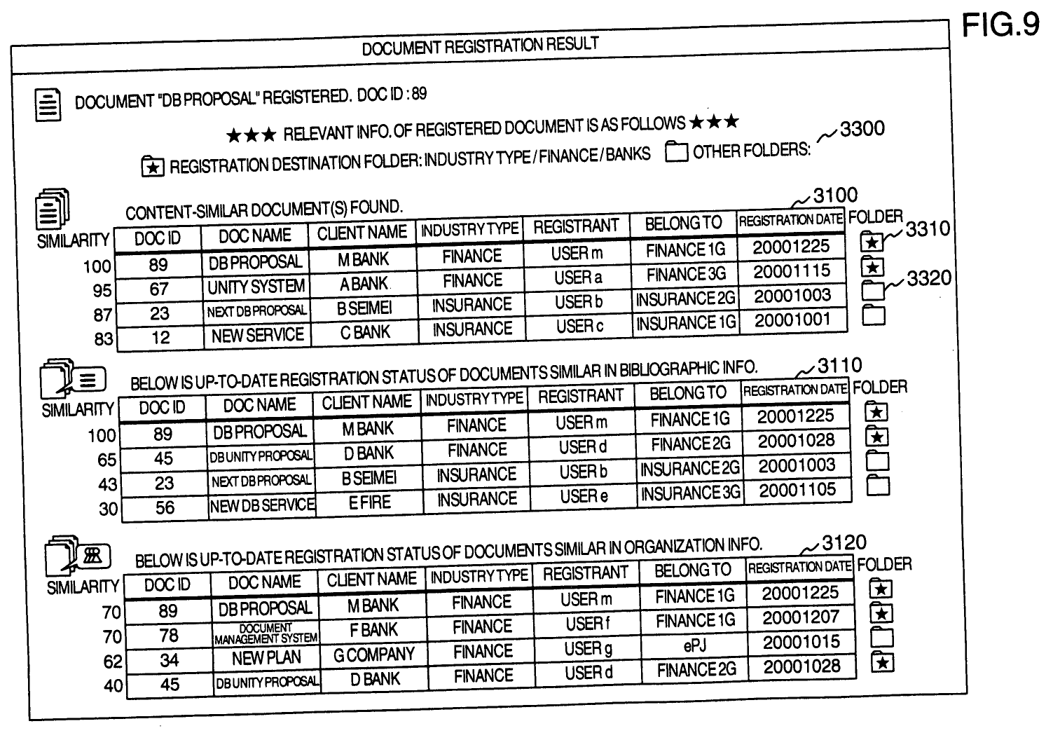

Firstly, an example of a folder configuration for document registration is shown in FIG. 8. The folder structure of FIG. 8 is based on a viewpoint of industry types, wherein a folder with a first hierarchical level is for “Industry Type” whereas second hierarchical folders are “Common”, “Finance” and “Insurance”. One example is that in a case the user designates a “Banks” folder 3200 of FIG. 8 as a registration destination of a document M, a registration result view such as shown in FIG. 9 is to be displayed.

FIG. 9 is an exemplary document registration result view in the case of document registration while designating a folder.

On the document registration result view of FIG. 9, folder information 3300 is displayed in addition to the display contents of the document registration result view of FIG. 6. In the folder information 3300, there are explained that folder icons with star marks added thereto are indicative of the folders with a document M “DB Proposal” registered to each of them, that is, “Industry Type/Finance/Banks”, whereas folder icons with no star marks added thereto are for indication of the remaining folders.

In the document registration result view of FIG. 9, it displays, in units of documents of related information, whether such a document has been registered to the same folder of a to-be-registered or “registration” document M. In the case of registration to the same folder as the registration document M, display a folder icon 3310; alternatively if registration is made to a different folder then display a folder icon 3320.

For example, it is understandable that a document “Unity System” of a document ID 67 is presently registered to the same folder as the registration document M. On the other hand, a document “Next-Term DB Proposal” of document ID 23 is registered to a different folder from that of the registration document M, e.g. a “Life Insurance” folder 3210 of FIG. 8, so a folder icon 3320 is being displayed.

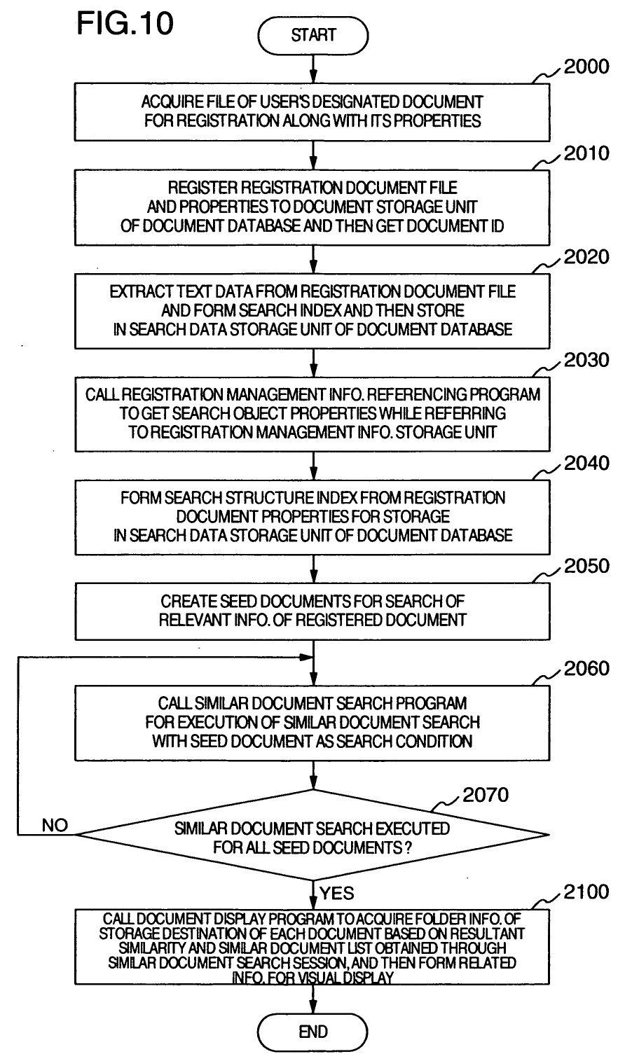

An explanation will next be given of a detailed procedure of document registration processing of the document registration program 110 of this embodiment by use of a flowchart of FIG. 10 below.

Main part of the processing flow covering from step 2000 to step 2070 is the same as the flowchart of FIG. 7; thus, an explanation thereof is eliminated herein for brevity purposes only.

At step 2100, call the document display program 140 for acquisition of folder information of a storage destination of each document based on the similarity and list of similar document(s) as have been obtained as a result of a similar document search; then, prepare related information thereof, which will then be visually displayed.

The above is the explanation of the practical procedure of the document registration processing of the document registration program 110 of this embodiment.

An explanation will next be given of the user's operations with respect to folder icons. Upon clicking of a folder icon 3310 or 3320 of FIG. 9, it is possible to refer to any documents being presently registered to such folder.

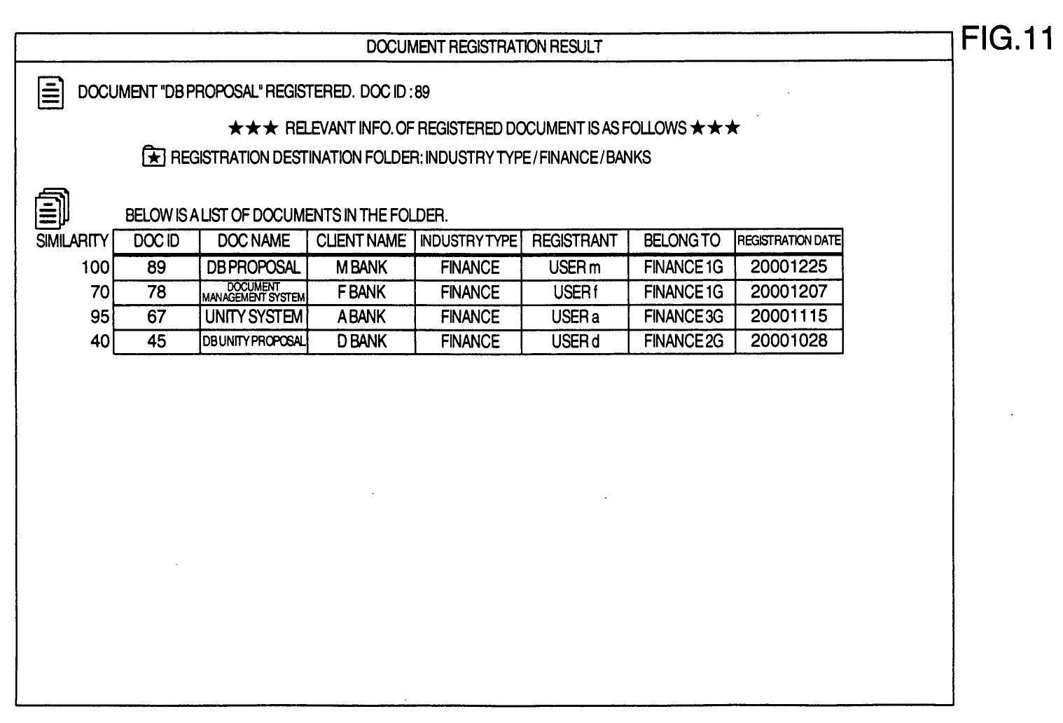

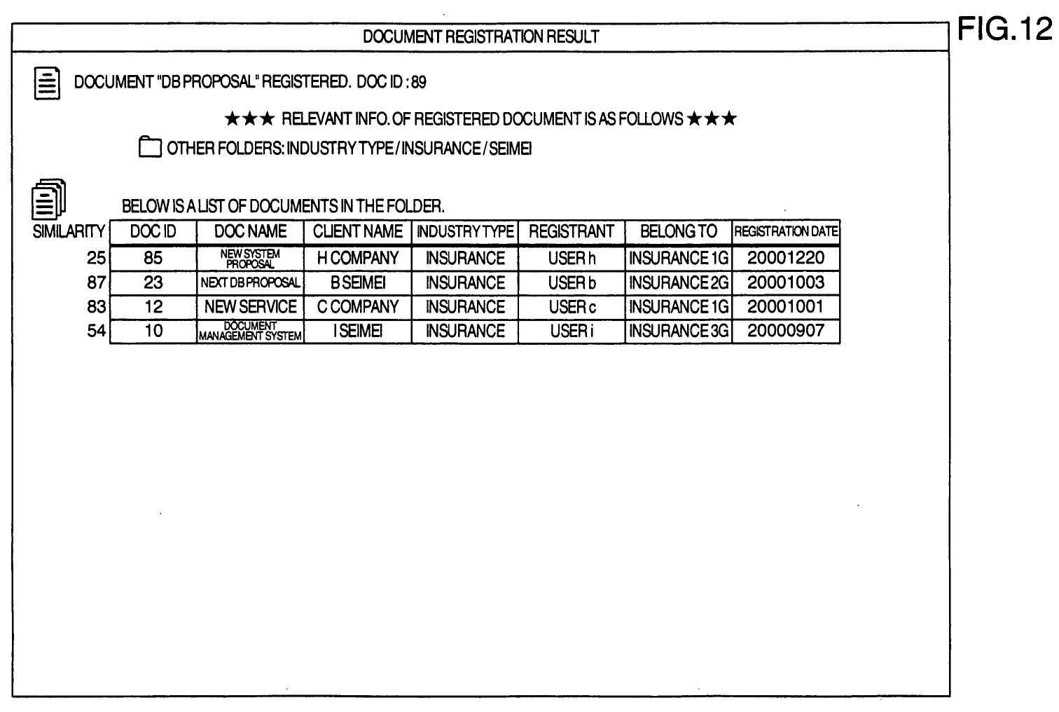

For instance, in the event that the user clocks the folder icon 3310 of FIG. 9, a list of those documents residing within the registration destination folder “Industry Type/Fiance/Banks” is to be displayed on the document registration result view of FIG. 11. In such a case, each document is displayed together with its own similarity of content relative to a document being registered. Alternatively when clocking the folder icon 3320 of FIG. 9, a list of documents within another folder “Industry Type/Insurance/Life” is displayed in the document registration result view of FIG. 12. In this case also, each document is displayed in association with its own similarity of content relative to the document being registered.

Whenever the user designates his or her preferred registration destination folder upon registering of a document, notification is made of any available related information of more than one similar document within the registration destination folder. Whereby, it becomes possible for the user to grasp any beneficial relevant information within the registration designation folder through the user's information publication, which in turn permits establishment of motivation of positive participation in information/knowledge sharing. In addition, as it becomes possible to judge whether such folder is appropriate for use as a destination of registration, which in turn gives a sense of security to the document provider side resulting in removal of any possible minus (obstruction) factors as to information sharing; thus, the information sharing may further be activated.

In addition, whenever the user designates a registration destination folder upon his or her registration of a document, there is also notified the related or relevant information of any available similar documents residing within folders other than the registration destination folder. Whereby it becomes possible to grasp relevant information with respect also to those folders other than the aimed or “target” folder, which in turn makes it possible for the user to obtain useful business information while referring to the documents that have been registered in a wide variety of viewpoints. Additionally in a case the user judges that a folder other than the target folder is deemed to be more appropriate for use as the registration destination, s/he is enabled to take a proper action such as changing the registration destination or other similar suitable actions, which in turn gives a sense of security to the document provider side resulting in removal of any possible minus (obstruction) factors as to information sharing; thus, the information sharing may further be activated. The above is the explanation of the second embodiment of the invention.

### Third Embodiment

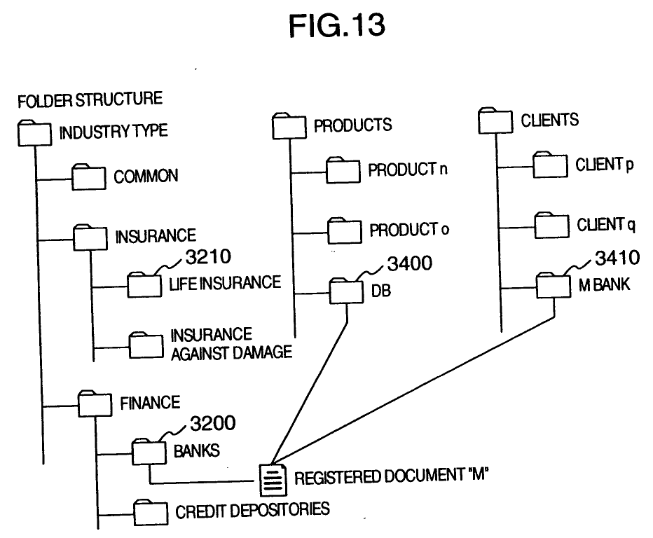

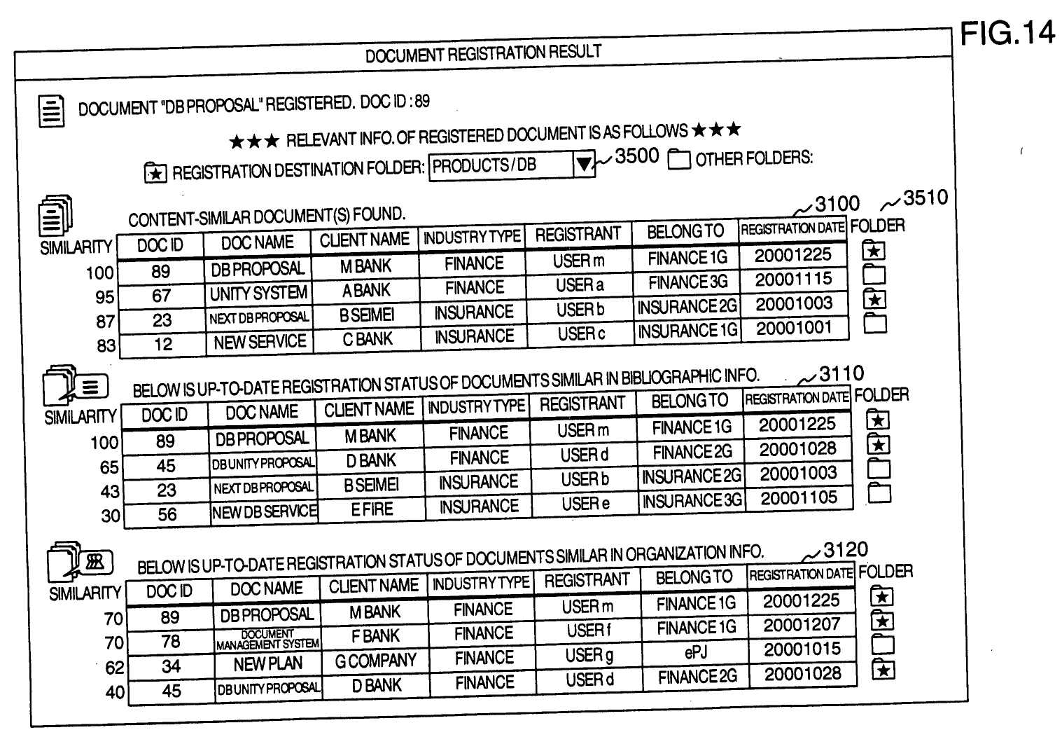

An explanation will be given of a case of registration of a document while letting it be associated with a plurality of folders, as a third embodiment of the present invention, in conjunction with some of the accompanying drawings. First see FIG. 13, which shows an exemplary folder structure for document registration. The folder structure of FIG. 13 is based on three different viewpoints: industry types, products, and clients. For example, it is possible for the computer user to designate as his or her preferred destination for registration of a document M a “Banks” folder 3200, a “DB” folder 3400 and an “M Bank” folder 3410 of FIG. 13. In such case, a document registration result view such as shown in FIG. 14 is to be displayed as a result of the registration. FIG. 14 is an example of the document registration result view in a case a document was registered while designating a plurality of folders.

In the document registration result view of FIG. 14, it is possible to change or switch between display patterns of resultant related information in a viewpoint of the folder structure. In the case of switching between related information displays, click a list box 3500 of a registration destination folder shown in FIG. 14. Upon clicking of the list box 3500, a list of registration destination folders is displayed as a menu. One example is that in the case of a registration document M, “Industry Type/Finance/Banks” and “Products/DB” plus “Clients/M Bank” are displayed in the form of a menu, which permits the user to choose his or her desired folder from among them. As a result, a folder icon 3510 pursuant to the folder switching is displayed.

Accordingly, even in the case of document registration with a plurality of folders designated at a time, it is possible for the user to grasp not only the related information residing within the registration destination folders but also the related information within other folders, and thus becomes possible to obtain any available useful business information while referring to documents as registered in a variety of aspects. To be brief, it is possible for the user to grasp any beneficial relevant information through document publication and registration, which in turn makes it possible to accomplish motivation of positive or aggressive participation in information-sharing/knowledge-sharing to thereby enable successful activation of information/knowledge sharing with increased efficiencies. What is stated above is the explanation of the third embodiment of the invention as disclosed and claimed herein.

From the foregoing, it becomes possible for the user to grasp related information beneficial to himself or herself by way of the information publication.

It should be further understood by those skilled in the art that the foregoing description has been made on embodiments of the invention and that various changes and modifications may be made in the invention without departing from the spirit of the invention and the scope of the appended claims.

1-14. (canceled)

15. A document information managing method for use in a document information managing apparatus which stores a plurality of registered documents to be managed, the document information managing apparatus being connected to at least one terminal device via a network and including a similar document searching means for searching the plurality of registered documents based on a seed document, comprising the steps of:
receiving, from a terminal device, a request for registration of a document created by a user;
extracting, from the requested document, text data concerning contents of the requested document in response to the request;
searching, by the similar document searching means, the plurality of registered documents stored in the document information managing apparatus, based on the text data thus extracted as a seed document, to thereby obtain related information of a registered document having similarity with respect to the requested document; and
notifying the terminal device of the related information.

16. A document information managing method for use in a document information managing apparatus which stores a plurality of registered documents to be managed, the document information managing apparatus being connected to at least one terminal device via a network and including a similar document searching means for searching the plurality of registered documents based on a seed document and a property defining means for defining a property to be searched, comprising the steps of:
receiving, from a terminal device, a request for registration of a document created by a user;
extracting, from the requested document, at least one property of the requested document in response to the request, the at least one property having been defined by the property defining means;
searching, by the similar document searching means, registered documents having a property similar to the at least one property of the requested document from among the plurality of registered documents stored in the document information managing apparatus, based on the at least one property thus extracted as a seed document, to thereby obtain related information of a registered document having similarity with respect to the requested document; and
notifying the terminal device of the related information.

17. The document information managing method according to claim 16, wherein the at least one property includes organization information as to an organization to which the user who created the requested document belongs.

18. A document information managing apparatus which stores a plurality of registered documents to be managed comprising:
at least one terminal device interconnected via a network;
a similar document searching means for searching the plurality of registered documents based on a seed document;
a means for receiving, from the terminal device, a request for registration of a document created by a user;
a means for extracting, from the requested document, text data concerning contents of the requested document in response to the request;
a means for searching, by the similar document searching means, the plurality of registered documents stored in the document information managing apparatus, based on the text data thus extracted as a seed document, to thereby obtain related information of a registered document having similarity with respect to the requested document; and
a means for notifying the terminal device of the related information.

19. A document information managing apparatus which stores a plurality of registered documents to be managed comprising:
at least one terminal device interconnected via a network;
a similar document searching means for searching the plurality of registered documents based on a seed document;
a property defining means for defining a property to be searched;
a means for receiving, from a terminal device, a request for registration of a document created by a user;
a means for extracting, from the requested document, at least one property of the requested document in response to the request, the at least one property having been defined by the property defining means;
a means for searching, by the similar document searching means, registered documents having a property similar to the at least one property of the requested document from among the plurality of registered documents stored in the document information managing apparatus, based on the at least one property thus extracted as a seed document, to thereby obtain related information of a registered document having similarity with respect to the requested document; and
a means for notifying the terminal device of the related information.

20. The document information managing apparatus according to claim 19, wherein the at least one property includes organization information as to an organization to which the user who created the requested document belongs.

21. A document information managing program for use in a document information managing apparatus which stores a plurality of registered documents to be managed, the document information managing program being connected to at least one terminal device via a network and including a similar document searching program for searching the plurality of registered documents based on a seed document, said document information managing program comprising the steps of:
receiving, from a terminal device, a request for registration of a document created by a user;
extracting, from the requested document, text data concerning contents of the requested document in response to the request;
searching, by the similar document searching program, the plurality of registered documents stored in the document information managing program, based on the text data thus extracted as a seed document, to thereby obtain related information of a registered document having similarity with respect to the requested document; and
notifying the terminal device of the related information.

22. A document information managing program for use in a document information managing program which stores a plurality of registered documents to be managed, the document information managing program being connected to at least one terminal device via a network and including a similar document searching program for searching the plurality of registered documents based on a seed document and a property defining program for defining a property to be searched, said document information managing program comprising the steps of:
receiving, from a terminal device, a request for registration of a document created by a user;
extracting, from the requested document, at least one property of the requested document in response to the request, the at least one property having been defined by the property defining program;
searching, by the similar document searching program, registered documents having a property similar to the at least one property of the requested document from among the plurality of registered documents stored in the document information managing program, based on the at least one property thus extracted as a seed document, to thereby obtain related information of a registered document having similarity with respect to the requested document; and
notifying the terminal device of the related information.

23. The document information managing program according to claim 22, wherein the at least one property includes organization information as to an organization to which the user who created the requested document belongs.
